(19) United States
(12) Patent Application Publication
(10) Pub. No.: US 2003/0016823 A1
(43) Pub. Date: Jan. 23, 2003

(54) Method and apparatus of using irrational numbers in random number generators for cryptography

(76) Inventor: Shine Chung, San Jose, CA (US)

Correspondence Address: OPPENHEIMER WOLFF & DONNELLY, P. O. BOX 10356, PALO ALTO, CA, 94303, US

(21) Appl. No.: 10/190,455

(22) Filed: Jul. 3, 2002

Related U.S. Application Data
(60) Provisional application No. 60/303,351, filed on Jul. 5, 2001.

(51) Int. Cl. H04L 9/00

(52) U.S. Cl. 380/46

(57) ABSTRACT

Innovative Innovative techniques over the conventional random number generators and randomization procedures are disclosed. The improved techniques use irrational numbers over the pseudo-random numbers generated by LFSR and use irrational number generators involve floating-point operations over the conventional integer arithmetic and logic operations. These innovative techniques can be applied to various cryptography applications such as hashes, ciphers, and random number generators. Particularly, the cubic root and inverse cubic root are two suitable functions for use in this invention.

### CROSS REFERENCE TO RELATED APPLICATION

Referenced is made to and priority claimed from U.S. Provisional Application No. 60/303,351, filed Jul. 5, 2001, entitled “Method and apparatus of using floating-point operations in data security,” which is incorporated herein by reference.

### COPYRIGHT NOTIFICATION

Pursuant to 37 C.F.R. §1.71(e), Applicant note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### BACKGROUND OF THE INVENTION

1. Field of the Invention

The present invention relates to cryptography, and more particularly, to use irrational numbers as random numbers and randomization procedures for various cryptographic applications.

2. Description of the Related Art

Cryptography always involves random numbers. Random numbers generated can be used to scramble data in hash functions, block ciphers, and stream ciphers, etc.

A hash function is used to scramble an input data with certain procedures such that generating results is straight forward but recovering the input from the results is extremely difficult. The hash function may incorporate keys for flexibility and more varieties. A set of data can be encrypted by ciphers that include a predetermined procedure and a key. If a cipher operates on data in real time, this cipher is referred to as a stream cipher. Otherwise if the cipher operates on data block-by-block, this cipher is referred to as a block cipher.

Either hash functions or ciphers depend on a procedure for randomization and a key for encryption and decryption. The cryptography in the past tended to keep both procedures and keys secret for maximum security. But the cryptography of current trend tends to keep the procedure open but hold the keys secret. If the effort of attacking a cipher takes as much as of trying out the keys exhaustively, this cipher is said to be very secure. A continuous bit stream of no repetitive patterns, call one-time pad, is the most secured cipher.

So far, all the randomization procedures in cryptography involve only integer arithmetic and logic operations, such as Boolean operation, modulus arithmetic, permutation, substitution, or multiply exponential. The conventional random number generators are based on Linear Feedback Shift Register (LFSR) of various kinds.

FIG. 1 is a block diagram depicting a prior art LFSR 100, that is commonly used in stream ciphers. In the LFSR 100, N number of flip-flops 104, 106, 108 . . . are connected in series. The output 102 of the LFSR 100 is the output of Nth flip-flop 110 (N−1). The exclusive-OR gates 112, 114, 116, . . . , 118 have one input from the exclusive-OR output of the flip-flop in the previous stage, and the other input from either the output of the current flip-flop or hardwired to logic 0. The switches 120, 122, 124, . . . , 126 select the input for each exclusive-OR gate either from a corresponding flip-flop outputs or from logic 0, to simply bypass the output of the current flip-flop. The output from the exclusive-OR gate 112 is connected to the input of the first flip-flop 104 to complete a feedback loop. The switches are selected to produce a 2^{N}−1 maximum length of pseudo-random numbers, according to algorithms well known to one skilled in the art.

FIG. 2 shows a block diagram of Data Encryption Standard (DES) system 200 that is commonly used in block ciphers. A 64-bit plaintext 202 is provided as input to the DES 200 and goes into the initial permutation 204. Through 16 rounds of encryption processes 206 through 208, and inverse initial permutation 210, to produce the output ciphertext 212. In the first round of encryption process 206, the 64-bit plaintext 202 input provided through the initial permutation 204 is split into a left 32-bit L₀ 214 and aright 32-bit R₀216. The right 32-bit R₀ 216 is the output 218 of left 32-bit L₁ 220 after the first round process 206. The right 32-bit R₀ 216 undergoes an encryption function f 222 with a key K₁ 224. The result is fed into an exclusive-OR gate 226 with the key K₁ 224 to produce the right 32-bit output R₁ 228 after the first round process 206. In summary, in a DES system, the function f takes the 32-bit input, expanding into 48 bits, exclusive-OR'ed with a 48-bit Kᵢ, and feeds into 6 S-boxes to perform substitution and then permutation for output. The key Kᵢ is the permutation of the original key K for round i.

Various cryptographic procedures, such as hash functions, stream ciphers, block ciphers, or random number generators, can be referred to Douglas Stinson's “Cryptography: Theory and Practice”, by CRC Press, 1995, for example.

The random number generators made of LFSR 100 suffer two problems: (1) the maximum length is finite and is limited to 2^{N}−1, no matter how large the number of stage N is; and (2) once 2N consecutive bits are known, the follow on bits can, be predicted. There are several variations of LFSRs by using multiple LFSRs combined with threshold logic. Nevertheless, they are still very vulnerable to attack. The block cipher such as DES has small key length that can be easily attacked by using fast computers in exhaustive trials.

Thus, there is a need for improved random number generators to approach the one-time pad and better randomization procedures other than using integer and Boolean logic operations in cryptography.

### SUMMARY OF THE INVENTION

This invention is about using irrational numbers as random numbers in the random number generators and using irrational number generators as randomization procedures for cryptographic applications.

Most irrational numbers show no repetitive bit patterns. The irrational bits generated with no correlation between bits, and are distributed statistically random that are perfect candidates for random numbers. The Irrational Number Generators (ING) can be applied to many cryptographic applications in various ways.

The irrational number generators can be used as random number generators, hash functions, or ciphers, etc. The irrational number generators can generate random numbers per se. A hash function can be embodied by combining the input data with a key and then undergoing an irrational number generator to produce a hashed output. Combining the input data with a key can be implemented by XORs, for example. Similarly, a block cipher can be embodied by combining the input data block by block with a key and undergoing an irrational number generator. If the irrational number generator is equipped with a buffer in the output, this bit stream can be combined with an input bit stream in real time for stream cipher. The combination can be implemented by XORs, for example.

The irrational number generator can be embodied as method, apparatus, or computer readable medium. The method is the underline procedure to perform irrational number generator. The hardware implementation can be realized by running a CPU executing instructions, or by designing in hardwire using random logic. The software implementation can be the instruction code stored in any kinds of memory devices for computers or CPUs to run on. The computer readable medium can be various kinds of memory devices such as semiconductor memory or magnetic storage devices.

The irrational number generator consists of weak key filter, pre-scale, integer-to-floating conversion, floating-point operation, floating-to-integer conversion, bit skip, deskew, and truncation units.

The crucial part of the irrational number generator is the floating-point operation. The floating-point operation can be any functions that can generate irrational numbers such as sinusoidal, logarithmic, exponent, cubic root or higher root functions. The preferred embodiments are to choose those functions that can produce quality irrational numbers and yet easy to implement. Though the square-root function is easy to implement, the results generated show repetitive patterns when represented in continued fraction. Therefore, the ciphers made of square-root can be easily attacked. The cubic root and inverse cubic root are preferred embodiments.

Other aspects and advantages of the invention will become apparent from the following detailed description, taken in conjunction with the accompanying drawings, illustrating by ways of example the principle of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram showing a Linear Feedback Shift Register (LFSR) that is commonly used as a stream cipher;

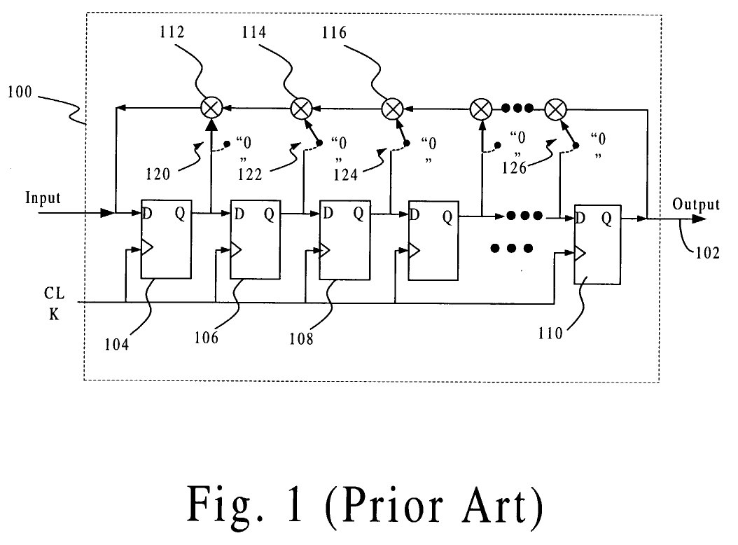

FIG. 2 is a block diagram depicting a Data Encryption Standard (DES) system that is commonly used in a block cipher;

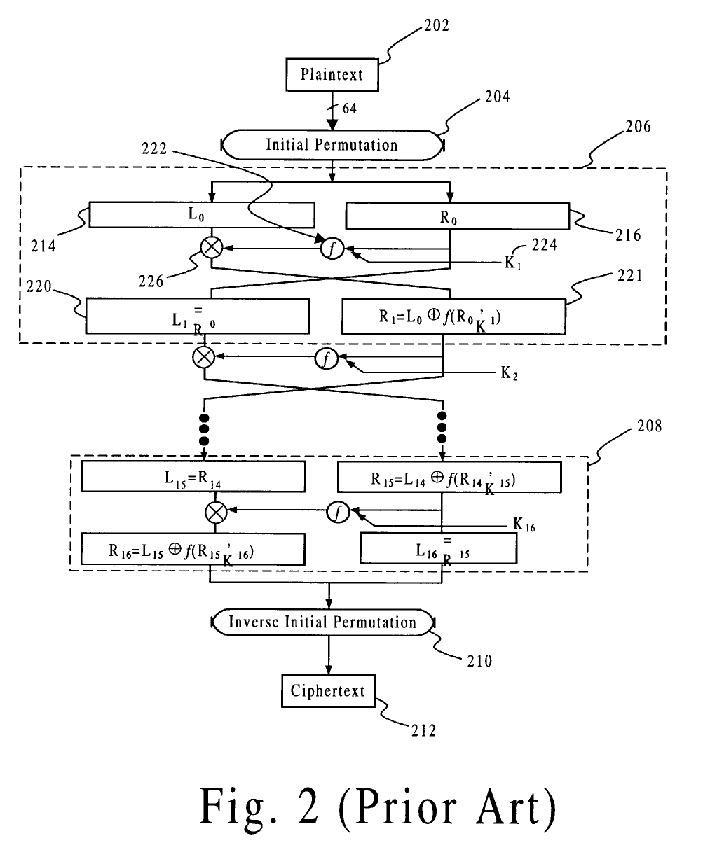

FIG. 3 is an exemplary one embodiment illustrating implementing an irrational number generator implemented in hash functions of the present invention;

FIG. 4 is an exemplary embodiment of depicting having an irrational number generator implemented in block ciphers of the present invention;

FIG. 5 is an alternative embodiment showing utilizing an irrational number generator implemented in block ciphers of the present invention;

FIG. 6 is an exemplary embodiment illustrating using an irrational number generators implemented in stream ciphers of the present invention;

FIG. 7 is a block diagram showing an irrational number generator of the present invention;

FIG. 8 is a table showing a selection table of cubic root function in radix 4 SRT method using 4 bits of partial results Q and 9 bits of partial remainder P for indexing; and

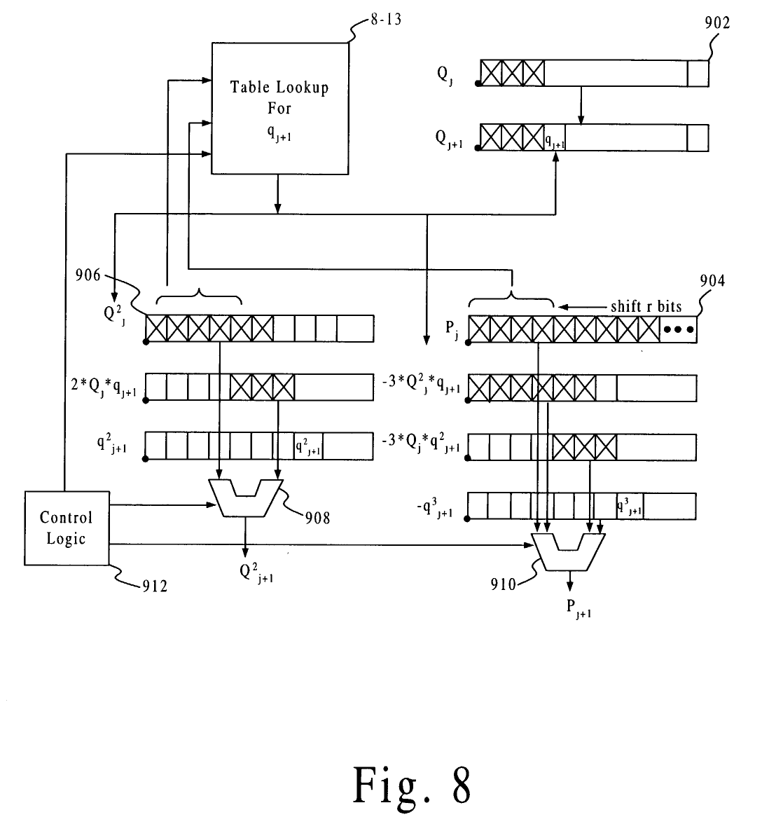

FIG. 9 is a block diagram depicting a hardware embodiment in generating cubic root for radix r SRT method.

### DETAILED DESCRIPTION OF THE INVENTION

The present invention utilizes irrational numbers as random numbers and irrational number generators set forth as encryption processes for various cryptographic applications.

Most irrational numbers show no repetitive patterns and are statistically random. If the irrational numbers and the processes of generating cryptographic applications are properly chosen, the bit stream generated is close to the one-time pad that can result in a highly secured code. Some irrational numbers when represented in certain forms can show some traits of repetitive patterns. For example, the square root of any integers, when represented in a continued fraction, always shows repetitive patterns. The well-known irrational number “e”, the base of the natural logarithm, when represented in continued fractions, show some traits of predictability:

$$e = 2 + \frac{1}{1 +} \frac{1}{2 +} \frac{1}{1 +} \frac{1}{1 +} \frac{1}{4 +} \frac{1}{1 +} \frac{1}{1 + 6} … ,$$

However, a cubic root of 2 shows no repetitive patterns when represented in continued fraction for more than 50 terms.

The irrational number generators can be readily embodied for various kinds of cryptographic applications such as hash functions, block ciphers, and stream ciphers, etc.

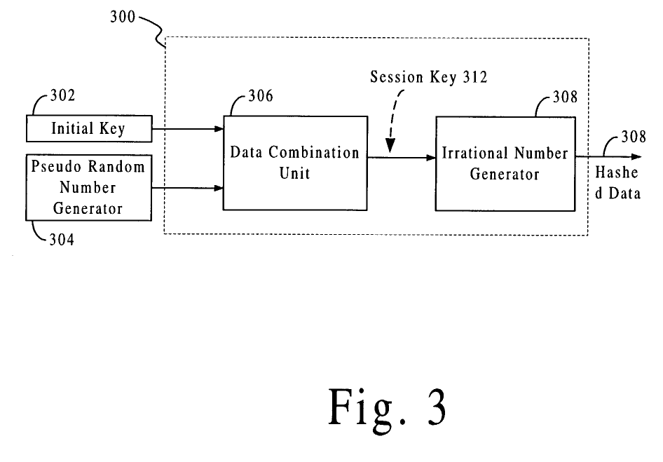

FIG. 3 is a block diagram illustrating an exemplary embodiment of using irrational number generator implemented in a hash function 300 of the present invention. The input data, i.e., the initial key 302, combined with a random number provided by a pseudo random number generator 304 in the data combination unit 306 and then input to a irrational number generator 308 to produce the hashed data 310. The data combination unit 306 can be implemented on the one hand in bit-by-bit exclusive-OR gates in a simple logic, or can be implemented in complicated permutation, substitution, or modulus arithmetic of all kinds. The hash function 300 is normally used to scramble the key 302 with a random number into a session key 312. The one-way hash function when applied to the original key 302 can protect the key from being recovered.

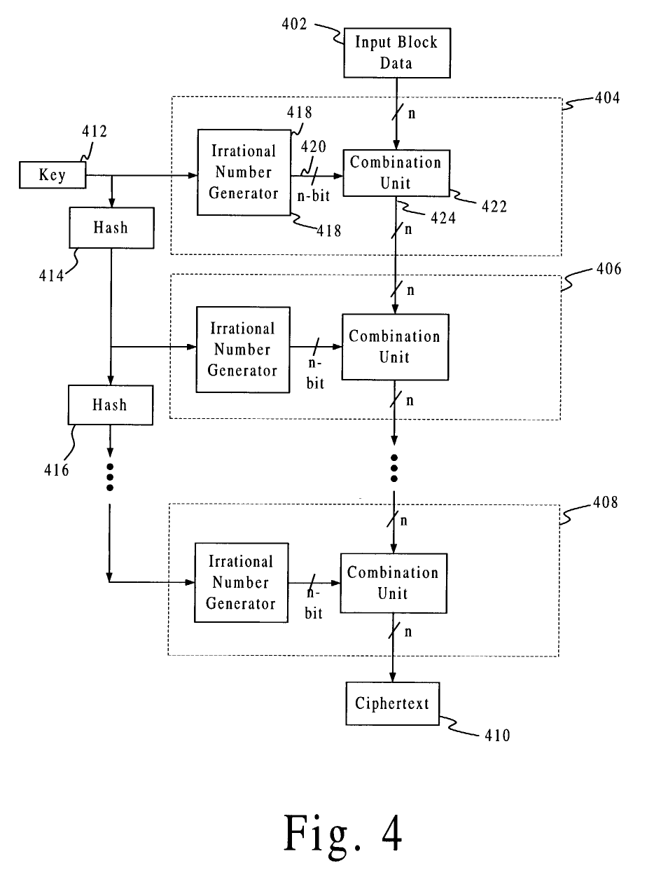

FIG. 4 is a block diagram depicting an exemplary embodiment of using irrational number generator in a block cipher in the present invention. The input data 402 goes through m rounds of encryption procedure 404 through 408 to generate the ciphertext output 410. The input key 412 is scrambled in hash units 414, 416, . . . , to generate a new session key for each round of scrambling. In the first round of encryption 404, the key 412 goes into an irrational number generator 418 to produce an n-bit result 420 and then are combined with the input data 402 in the combination unit 422 to generate an output 424. The combination unit 422 can be implemented on the one hand in bit-by-bit exclusive-OR gates in a simple logic, or alternatively can be implemented in complicated permutation, substitution, or modulus arithmetic of all kinds. The same encryption blocks can be repeated m rounds to increase security. At each round, the key is further hashed to provide more protection.

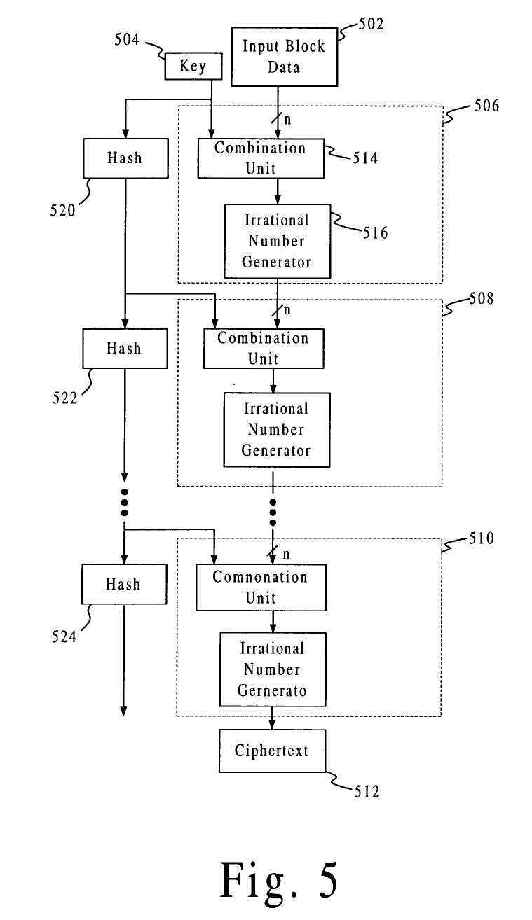

FIG. 5 is an alternative embodiment showing utilizing an irrational number generator implemented in alternative block ciphers of the present invention. The input data 502 with keys 504 goes through m rounds of encryption procedure 506 through 510 to generate the ciphertext 512 output. In the first round of encryption 506, the input data 502 is combined with a key 504 in a combination unit 514 and are input to an irrational number generator 516 to produce output 518 for the next round of encryption 508. The combination unit 514 can be implemented on the one hand in bit-by-bit exclusive-OR gates in a simple logic, or alternatively in-complicated permutation, substitution, or modulus arithmetic of all kinds on the other hand of complicated logic. The key can be further hashed in 520, 522, 524 . . . for the subsequent rounds 508, . . . , 510 to provide more security. The number of rounds m and the actual implementation may vary and still within the scope of the invention for those skilled in the art.

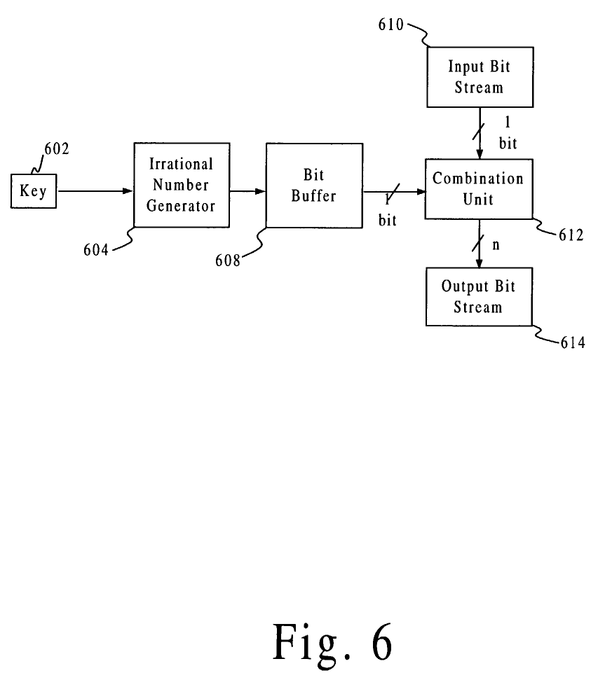

FIG. 6 is an exemplary embodiment illustrating using an irrational number generators implemented in a stream cipher of the present invention. A key 602 is connected as an input to an irrational number generator 604 to generate a bit stream of statistically random bits 606. This bit stream 606 is stored in a bit buffer 608 to accommodate the different rates of input between the incoming bit stream 610 and the random bit stream 606. The bit buffer 608 can be implemented as a First-In-First-Out (FIFO) buffer, or simple in a memory either single-ported or dual-ported. Then the buffered bit stream is combined with the input bit stream 610 in the combination unit 612, and then output to bit stream 614. The combination unit 612 can be implemented simply in exclusive-OR (XOR) gates, or through any integer or Boolean operations.

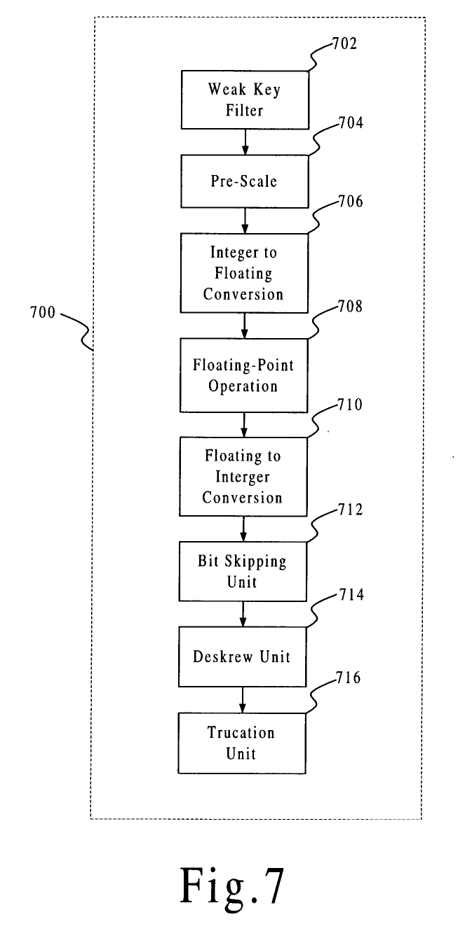

FIG. 7 is a block diagram showing an irrational number generator 700 of the present invention. The irrational number generator 700 includes a weak key filter 702, a pre-scale unit 704, an integer-to-floating conversion 706, floating-point operation 708, floating-to-integer conversion 710, bit skip unit 712, deskew unit 714, and truncation unit 716.

The floating-point operation 708 is a key feature of the irrational number generator 700. A variety of floating-point operations such as sinusoidal, exponent, logarithmic or roots are capable of producing a stream of irrational bits. In a preferred embodiment, the floating-point operation 708 has the following features: (1) generate irrational numbers without repetitive patterns in any representations; (2) resultant bits are statistical random; and (3) hardware or software implementation efficient. A square root function can generate irrational numbers and are implementation efficient. But any square root of an integer always shows repetitive patterns when represented in continued fraction. For example,

$$\sqrt{2} = 1 + \frac{1}{2 +} \frac{1}{2 +} \frac{1}{2 +} \frac{1}{2 +} \frac{1}{2 +} \frac{1}{2 +} \frac{1}{2 + 2} …$$

$$\sqrt{3} = 1 + \frac{1}{1 +} \frac{1}{2 +} \frac{1}{1 +} \frac{1}{2 +} \frac{1}{1 +} \frac{1}{2 +} \frac{1}{1 + 2} … ,$$

Therefore, the square root function is not suitable to generate irrational numbers for cryptography. Two particularly suitable floating-point operations are cubic root and inverse cubic root.

The sinusoidal function, sin(x), is used to illustrate the different functional blocks in the irrational number generator 700. For those skilled in the art should understand that any floating-point operations can be applied to this invention and are still within the scope of this invention. The weak key filter 702 eliminates weak keys such as 0, π/2, or π for sinusoidal function, and perfect cubic or nearly perfect cubic numbers for cubic root function. After the weak key is found and then discarded or replaced, the key goes to prescale unit 704 to scale the key into a suitable range. If the key is a 48-bit integer as an input to a sinusoidal function, the accuracy of π needs to be many times of 48 bits to scale the input into the appropriate quadrant before actual calculation can be carried out. However, if the key is scaled to a 6-bit integer with 42-bit fraction, the accuracy requirement for π can be much less. After the key is pre-scaled, this key is converted into floating-point format in integer-to-floating conversion unit 7706, and then a function sin(x) is applied to in the floating-point operation 708. The result of the floating-point operation 708 is converted back into integer in floating-to-integer conversion unit 710 with proper post-scaling. The bit skip unit 712 receives a stream of irrational bits from the floating-to-integer conversion unit 710. The bit skip unit 712 skips the integer portion and also the large fractional portion. Therefore, the output of the bit skip unit 712 contains a small fractional portion of the irrational bit stream. The deskew unit 714 further increases the randomness by discarding “00” or “11” and replaced “01” by “1” and “10” by 0, for example. The methods of deskewing a bit stream may vary and the different schemes of deskewing are still within the scope of this invention. The truncation unit 716 truncates the remaining fractional portion of the irrational bit stream into finite length. Not all the functional blocks in FIG. 7 are needed for a given floating-point operation. The actual implementations may vary for the functional blocks 702 through 716 and are still within the scope of the invention for those skilled in the art.

An example of the floating-point operation 708 in irrational number generator 700 is illustrated as follows. The key is, for instance, 41 or 0010,1001 binary. With properly prescaled in 704 by 16, the input to the sinusoidal function is 2.5625 decimal or 10.1001 binary. The output of the sinusoidal function sin(x) in 708 is 0.547264749925465 . . . decimal, or 0.100011000001100110001010111 . . . binary. If the first 6 bits of the fraction is skipped in 712, the result is 000001100110001010111 . . . binary. After the deskew unit 714, the result is 101000. . . .

Two embodiment of the floating-point operation 708 in the irrational number generator 700 are cubic root or inverse cubic root. The cubic root or inverse cubic root functions can be implemented by either iterative method or direct bit-by-bit method.

The inverse cubic root of “a” can be obtained by solving the following equation by Newton-Ralphson's iteration:

f(x)=1/x³−a

After the initial guess x, the next iteration x′ can be found as:

x′=x−f(x)/f′(x)=x/3(4−ax²)

The initial guess can be obtained by looking up a table for accuracy up to 8 bits, for example. The first iteration will get the result accurate to 16 bits. The second and third iterations can provide accuracy up to 32 and 64 bits, respectively. The accuracy also depends on the available bits in the multiplication and addition units.

Similarly, the cubic root of “a” can be calculated by solving the following equations iteratively and multiplying the result by “a”:

f(x)=1/x³−a²

The next result by Newton-Ralphson's method is

x′=x−f(x)/f(x)=x/3(4−a²x²)

After several iterations until the desired accuracy xₙ is reached, the cubic root of “a” can be obtained as

{cube root}\sqrt{a}=axₙ

In the iterative method, calculating inverse cubic-root is simpler than cubic root by two multiplications. This iterative method can be implemented in software or firmware routines. More bits can be generated by a similar procedure.

The direct bit-by-bit method can generate one bit, two bits, or more bits at a time, the so-called radix 2, 4, 8 or higher radix method. The result bits can be all positives or can be positive and negative mixed, the so-called Sweeney-Robertson-Toucher (SRT) method. The SRT method allows the resultant bits be negative, such that there can be more than one way to determine the partial resultant bits in each time. The redundant representation in SRT method offers some freedom in choosing the partial resultant bits. The partial root remainder can be negative as quite different from the regular pencil-and-paper calculation, the non-SRT method.

The procedure to obtain a cubic root can be formulated as follows:

Let P₀ be the number for cubic root. The partial resultant bits q₁, q₂, q₃ . . . are obtained one at a time. The partial result is

$${Q}_{j} = {\sum }_{i = 1}^{j} {q}_{i} {r}^{- 1} , \qquad ( eq . 1 )$$

where r is the radix and j is the j-th calculation. The partial resultant bits are carefully chosen such that the partial root remainder

Pⱼ=r^{J}(P₀−Q_{J}³) (eq. 2)

will be minimized.

Based on eq. (2), the recursive relationship between two adjacent partial remainders Pⱼ and Pⱼ₊₁ can be readily known as

P_{J+1}=rP_{J}−r^{J+1}(Qⱼ₊₁³−Qⱼ³) (eq. 3)

The residual error in each bit calculation can be known as:

$$\sqrt[3]{{P}_{0}} - {Q}_{j} = {\sum }_{i = j + 1}^{∞} {q}_{i} {r}^{- 1} \qquad ( eq . 4 )$$

The bounds in the residual error for non-SRT methods are:

$$0 \leq \sqrt[3]{{P}_{0}} - {Q}_{j} = {\sum }_{i = j + 1}^{∞} {q}_{i} {r}^{- i} < {\sum }_{i = j + 1}^{∞} {q}_{max} {r}^{- i} = {kr}^{- j} \qquad ( eq . \text{5a} )$$

and for SRT method:

$$\vert \sqrt[3]{{P}_{0}} - {Q}_{j} \vert = {\sum }_{i = j + 1}^{∞} {q}_{i} {r}^{- i} \leq {\sum }_{i = j + 1}^{∞} {q}_{max} {r}^{- i} = {kr}^{- j} \qquad ( eq . \text{5b} )$$

where qₘₐₓ=r−1, and k=1 for non-SRT; and qₘₐₓ=log₂(r), and k=qₘₐₓ/(r−1) for SRT method.

Based on eq. (2),(3), and (5a), the bounds for each partial remainder can be readily obtained for non-SRT method as:

0≦Pⱼ<r^{J}((Qⱼ+kr^{-J})³−Qⱼ³) (eq. 6a)

The goal is to choose qⱼ₊₁ based on Qⱼ and Pⱼ such that Pⱼ₊₁ can satisfy the same eq. (6a) for index j+1. Substituting eq (1), (3) into eq. 6(a), the inequalities for range of P_{J} can be found for non-SRT as:

r^{j}[((Q_{J}+q_{J+1}r^{-J-1})³−Q_{J}³]≦P_{J}<r^{J}[((Qⱼ+(q_{J+1}+k)r^{-J-1})³−Qⱼ³] (eq. 7a)

The equation (7a) limits qⱼ₊₁ selection based on the ranges of Pⱼ and Qⱼ. Particularly, for radix 2, r=2:

qⱼ₊₁=1 . . . 2^{j}[((Qⱼ+2^{-j-1})³−Q_{J}³]≦P_{J}<2^{j}[((Q_{J}+2^{-j})³−Q_{J}³] (eq. 8a.1)

q_{J+1}=0 0≦P_{J}<2^{J}[((Q_{J}+2^{-J-1})³−Q_{J}³] (eq. 8a.2)

The selection rule for radix 2 non-SRT method is straight forward. The partial result bits qⱼ₊₁ can be either 0 or 1 depending on the result of P_{J} whether or not P_{J} <2¹[((Qⱼ+2^{-J-1})³−Qⱼ³]. Only one subtraction is involved in determining each partial result bit. The non-restoring method can be applied: if the partial remainder is negative after one subtraction, the next round to generate the next partial remainder will be changed to addition.

Similarly, for radix 4, r=4, the selection rules for qⱼ₊₁ are:

qⱼ₊₁=3 . . . 4^{j}[((Q_{J}+3·4^{-j-1})³−Q_{J}³]≦P_{J}<4^{j}[((Q_{J}+4^{-j})³−Q_{J}³] (eq.9a)

qⱼ₊₁=2 . . . 4^{J}[((Qⱼ+2·4^{-J-1})³−Qⱼ³]≦Pⱼ<4^{J}[((Qⱼ+3·4^{-J-1})³−Qⱼ³]

qⱼ₊₁=1 . . . 4^{j}[((Q_{J}30 4^{-j-1})³−Qⱼ³]≦P_{J}<4^{j}[((Qⱼ+2·4^{-j-1})³−Qⱼ³]

qⱼ₊₁=0 0≦P_{J}<4^{J}[((Q_{J}+4^{-j-1})³−Qⱼ³]

To determine whether or not qⱼ₊₁ is 0, 1, 2, or 3, three comparisons are needed. Each comparison would need an adder. The hardware resources consideration may not favor this approach.

Instead, the SRT method of radix 4 or higher for cubic root calculation is more favorable and is shown in the following.

Based on eq. (2),(3), and (5b), the bounds for each partial remainder can be readily obtained for SRT method as:

r^{J}((Qⱼ−kr^{-j})³−Qⱼ³)≦Pⱼ≦r^{j}((Qⱼ+kr^{-J})³−Qⱼ³) (eq. 6b)

The goal is to choose qⱼ₊₁ based on Qⱼ and Pⱼ such that Pⱼ₊₁ can satisfy the same eq. (6b) for index j+1. Substituting eq (1), (3) into eq. 6(b), the inequalities for ranges of Pⱼ can be found as:

r^{j}[((Qⱼ+(qⱼ₊₁−k)r^{-j-1})³−Q_{J}³]≦Pⱼ≦r^{j}[((Qⱼ+(qⱼ₊₁+k)r^{-j-1})³−Qⱼ³] (eq. 7b)

The equation (7b) limits the qⱼ₊₁ selection based on ranges of Pⱼ and Qⱼ. Particularly, for radix 2, r=2 and k=1, the selection rules are:

qⱼ₊₁=1 . . . 0≦P_{J}≦2^{j}[((Q_{J}+2^{-j})³−Q_{J}³] (eq. 8a.1)

qⱼ₊₁=0 . . . 2^{J}[((Q_{J}−2^{-J-1})³−Q_{J}³]≦P_{J}≦2^{J}[((Qⱼ+2^{-J-1})³−Q_{J}³] (eq.8a.2)

qⱼ₊₁=−1 . . . 2^{j}[((Qⱼ−2^{-j})³−Q_{J}³]≦P_{J}≦0 (eq. 8a.3)

The number for cubic root a=Pₒ can be normalized to be within ¼≦P₀<½ without loss of generality. Consequently, q₁=1 and Q₁=½. Based on eq. (8a. 1), (8a.2), and (8a.3), the following sets of selection criteria can be derived:

q_{J+1}=1 if Pⱼ≧0; qⱼ₊₁=−1 if Pⱼ<0. Selection criteria 1:

q_{J+1}=1 if P_{J}>0; q_{J+1}=0 if P_{J}=0; q_{J+1}=−1 if P_{J}<0. Selection criteria 2:

q_{J+1}=1 if \tilde{p}₀&(p₁|(\tilde{p}₂& \tilde{p}₃));qⱼ₊₁=0 if \tilde{p}₀& \tilde{p}₁&(\tilde{p}₂|\tilde{p}₃);q_{J+1}=−1 if p₀, Selection criteria 3:

where P_{J}=P₀.P₁P₂P₃ . . . in 2's complement, & and | are AND and OR in Boolean operations.

The same treatment can be extended to radix 4 through more elaboration. The number for cubic root a=P₀ can be normalized to be within 1/64≦P₀<⅛ and ¼≦Q<½ without loss of generality. Consequently, q₁=1 and Q₁=¼. For radix 4, r=4 and k=⅔, the selection rules for qⱼ₊₁ are:

$$\begin{matrix}{q}_{j + 1} = 2 & {4}^{j} [ ( {( {Q}_{j} + \frac{4}{3} {4}^{- j - 1} )}^{3} - {Q}_{j}^{3} ] \leq \\ & {P}_{j} \leq {4}^{j} [ ( {( {Q}_{j} + \frac{8}{3} {4}^{- j - 1} )}^{3} - {Q}_{j}^{3} ] \\ {q}_{j + 1} = 1 & {4}^{j} [ ( {( {Q}_{j} + \frac{1}{3} {4}^{- j - 1} )}^{3} - {Q}_{j}^{3} ] \leq \\ & {P}_{j} \leq {4}^{j} [ ( {( {Q}_{j} + \frac{5}{3} {4}^{- j - 1} )}^{3} - {Q}_{j}^{3} ] \\ {q}_{j + 1} = 0 & {4}^{j} [ ( {( {Q}_{j} - \frac{2}{3} {4}^{- j - 1} )}^{3} - {Q}_{j}^{3} ] \leq \\ & {P}_{j} \leq {4}^{j} [ ( {( {Q}_{j} + \frac{2}{3} {4}^{- j - 1} )}^{3} - {Q}_{j}^{3} ] \\ {q}_{j + 1} = - 1 & {4}^{j} [ ( {( {Q}_{j} - \frac{5}{3} {4}^{- j - 1} )}^{3} - {Q}_{j}^{3} ] \leq \\ & {P}_{j} \leq {4}^{j} [ ( {( {Q}_{j} - \frac{1}{3} {4}^{- j - 1} )}^{3} - {Q}_{j}^{3} ] \\ {q}_{j + 1} = - 2 & {4}^{j} [ ( {( {Q}_{j} - \frac{8}{3} {4}^{- j - 1} )}^{3} - {Q}_{j}^{3} ] \leq \\ & {P}_{j} \leq {4}^{j} [ ( {( {Q}_{j} - \frac{4}{3} {4}^{- j - 1} )}^{3} - {Q}_{j}^{3} ]\end{matrix} \qquad ( eq . \text{9b.1-5} )$$

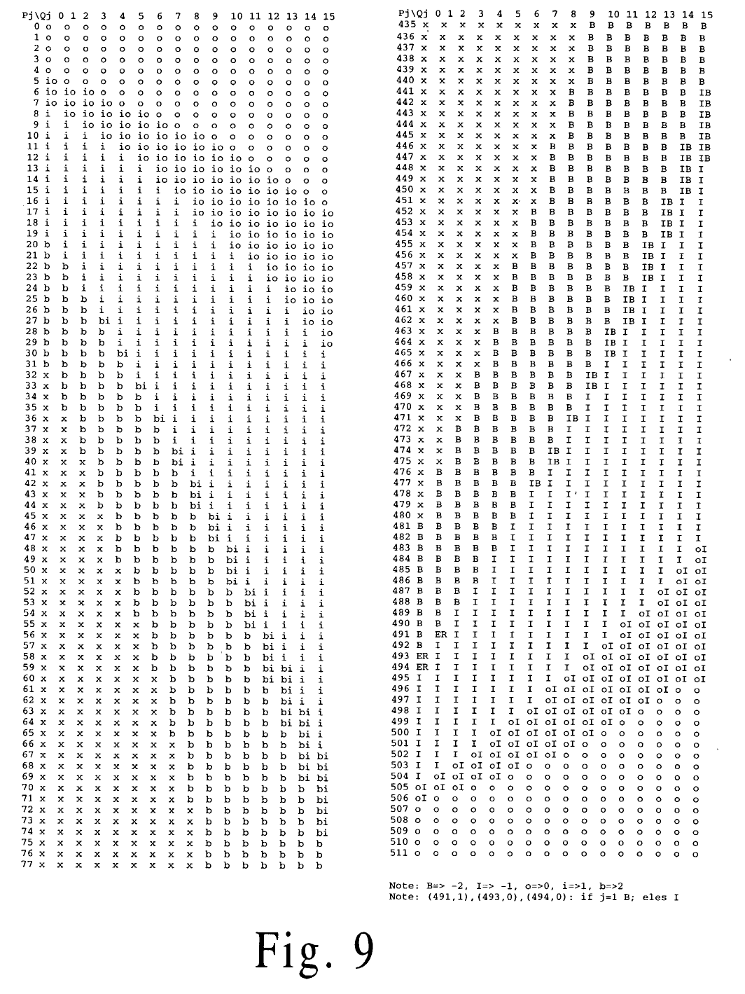

FIG. 9 is a table showing a selection table based on selection rules illustrated in eq . (9b. 1-9b.5). Four bits of Qⱼ=0.01a₀a₁a₂a₃ and 9 bits of P_{J}=P₀.P₁P₂P₃P₄P₅P₆P₇P₈ . . . are sufficient to look up a table to determine qⱼ₊₁, where p₀ is the sign bit in the 2's complement format. Three cells have different values for j=2 than the others j's. Note that some cells may have more than one selections. This is a unique property of the SRT method.

The selection criteria can be readily deducted from the Table 1 as:

# pⱼ=[p0,p1,p2,p3,p4,p5,p6,p7,p8] and qⱼ=[a0 a1 a2 a3]. 0 is MBS

# SRT-4 method for Cubic Root

# 1/64<=pⱼ<⅛, ¼<=qⱼ<½

if(p_{J}<=255)

if (pⱼ<=4+qj) q=0;

else if(q_{J}==0 && p_{J}<=19) q=1;

else if(qⱼ<=2 && pⱼ<=(18+3*qⱼ)) {q=1; }

else if(qⱼ<=6 && p_{J}<=(26+3*(q_{J}−3)) ) q=1;

else if(qⱼ>=7 && p_{J}<=(34+4*(q_{J}−6))) q=1;

else q=2;

if(p_{J}>255) # P_{J}<0

{p_{J}=512−p_{J};

if (p_{J}<=6+q_{J}) q=0;

else if(q_{J}==0 && pⱼ<=19) q=−1;

else if(qⱼ<=3 && pⱼ<=(21+2*(qⱼ−1))) q=−1;

else if(qⱼ<=7 && p_{J}<=(28+3*(qⱼ−4))) q=−1;

else if(q_{J}>=8 && p_{J}<=(41+4*(q_{J}−8))) q=−1;

else q=−2;

if (j==2 && qⱼ==1 && pⱼ==21) q=−2; #491

if (j==2 && qⱼ==0 && pⱼ==19) q=−2; #493

if (j==2 && qⱼ==0 && pⱼ==18) q=−2; #494

The procedure to calculate the resultant bits of a cubic root can be formulated step-by-step as:

1. Scale P₀ to be within 1/r³<=P₀<8/r³ so that 1/r<=Q<2/r;

2. q₁=1; Q₀=0; Q²₀=0; j=1; qbit=1/r; #qbit holds the bit position

3. qqbit=q_{J}*qbit;

4. Qⱼ=Qⱼ₋₁+qqbit; #partial results

5. Q²ⱼ=Q²ⱼ₋₁+2* Qⱼ₋₁*qqbit+qqbit*qqbit; #sqare of partial results

6. P₁=r*Pⱼ₋₁(3*Q²ⱼ₋₁+3* Qⱼ₋₁*qqbit+qqbit*qqbit)*qⱼ; #partial remainder

7. qⱼ₊₁=select (Pⱼ, Qⱼ,j);

8. qbit=qbit/r; j=j+1

9. Go to step 3 until sufficient bits are obtained.

This procedure can continue until the desirable bits are obtained. Note that the partial remainder in the last step could be negative, such that the final partial result may be larger than the actual result. This is quite different from the non-SRT method that the final partial result is always less than the actual number. Some adjustment and rounding may be necessary. For some P_{J}, Q_{J}, there may be more than one selection. For cryptography, there is a need to standardize the selection table. One example is to select those partial results that are close to zero.

The partial results from the SRT method may have positive and negative bits. The final cubic-root can be obtained by subtracting the positive bits by the negatives. This may involve very long bit length of subtraction, which may take a substantial amount of time to calculate.

One embodiment to reduce computation is to subtract the two types of bits for some block size at a time, 64 bits for example. An alternative embodiment is to exclusive-OR the two types of bits. Of course, the resultant bits of these two embodiments will not be identical to the cubic root.

The process of cubic root can be implemented in hardware. FIG. 9 is a diagram illustrating an examplary hardware embodiment of cubic root process of the present invention. The registers 902, 904, 906 store Q_{J}, P_{J}, and Q²_{J}, the partial result, partial remainder, and square of the partial result, respectively, at j-th clock cycle. After each calculation, they will be updated in the same registers with index j+1. The Q₁ and Q²ⱼ are initialized to 1/r and 1/r², respectively, when P₀ is scaled to be within [1/r³, 2/r³). The qb most significant bits of Q_{J}, and pb most significant bits of Pⱼ, are used to index a lookup table 900 for the next qⱼ₊₁. The lookup table can be implemented in ROM, RAM, PLA, flash, or random logic, for example. Each box in registers 902, 904, and 906 represents r bits according to radix r SRT method. Updating Q register 902 is straight-forward by placing the new qⱼ₊₁ in proper bit position, namely r(j+1)-th bits from the left. The Q² register 906 can be updated by adding 2·Qⱼ·qⱼ₊₁ and q²ⱼ₊₁ in an adder 908. Adding q²ⱼ₊₁ is simply putting q²ⱼ₊₁ in 2r(j+1)-th bit position from the left. Adding 2·Qⱼ·qⱼ₊₁ may need shifting and a few additions depending on how high the radix r is. Similarly, the P register 904 can be updated at the same time as the Q register 906 in a four-operand adder 910. When both Q_{J+1} and P_{J+1} are available, the q_{J+2} can be indexed in the next clock cycle to get the next r bits. The control logic 912 designed in state machines controls the operations in updating registers, indexing lookup table to generate r bits every clock.

Although the present invention has been described in terms of specific embodiment, it is anticipated that alterations and modifications thereof will no doubt become apparent to those skilled in the art. It is therefore intended that the following claims be interpreted as covering all such alterations and modifications as falls within the true spirit and scope of the invention.

What is claimed is:

1. A code generator for generating uncorrelated random bits, comprising:
a data combination unit operative to generate data by combining a key input with a random number, wherein said key is being scrambled with said random number; and
an irrational number generator operative to generate a stream of uncorrelated random bits from said combined data.

2. A code generator as recited in claim 1, wherein said irrational number generator including a floating-point operation operative to generate said stream of uncorrelated random bits from said combined data.

3. A code generator as recited in claim 1, wherein said random bits have an integer and a fraction portion.

4. A code generator as recited in claim 3, wherein said irrelational number generator further comprising:
a filter operative to eliminate weak keys from said combined data;
a bit skipping unit operative to generate an output from a part of the fraction portion by disregarding the integer portion and a predetermined section of the fraction portion;
a deskew unit operative to generate a random output from said partial fraction output; and
a truncation unit operative to generate a predetermined length of a bit stream from said random output of said partial fraction output.

5. A code generator as recited in claim 4, wherein said filter further including a floating-point operation for determining the uncorrelatedness of said bits of said bit stream output.

6. A code generator as recited in claim 5, wherein said floating-point operation further enhances the uncorrelatedness of said bits of said bit stream output.

7. A code generator as recited in claim 5, wherein said floating-point operation and length of said key provide the basis for said skipping unit in determining the number of fraction bits to disregard.

8. A code generator as recited in claim 4, wherein said deskew unit further increases the randomness of said random output.

9. A code generator as recited in claim 8, wherein said deskew unit increase the randomness by eliminating successive 1's and 0's and further by replacing consecutive “01” and “10” with a single distinguished bit.

10. A code generator as recited in claim 4, wherein said irrational number generator further comprising:
a prescale unit converting said combined data after eliminating weak keys to a predetermined range;
a converter converting said prescaled combined data from an integer to a floating-point number;
a floating-point operation unit operative to generate an output through the operations of obtaining the cubic root of the floating-point number; and
a second coverter converting said cubic root of the floating-point number to an integer.

11. A code generator as recited in claim 4, wherein said irrational number generator further comprising:
a prescale unit converting said combined data after eliminating weak keys to a predetermined range;
a converter converting said prescaled combined data from an integer to a floating-point number;
a floating-point operation unit operative to generate an output through the operations of obtaining the inverse cubic root of the floating-point number; and
a second coverter converting said cubic root of the floating-point number to an integer.

12. A method of generating uncorrelated random bits, comprising:
combining a key input with a random number, wherein said key is being scrambled with said random number; and
generating a stream of uncorrelated random bits from said combined data.

13. A method of generating uncorrelated random bits as recited in claim 12, wherein said process of generating a stream of uncorrelated random bits including a floating-point operation.

14. A method of generating uncorrelated random bits as recited in claim 12, wherein said random bits have an integer and a fraction portion.

15. A method of generating uncorrelated random bits as recited in claim 14, wherein said process of generating a stram of uncorrected random bits further comprising:
eliminating weak keys from said combined data;
generating a first output from a part of a fraction portion by disregarding an integer portion and a predetermined section of the fraction portion of said combined data after eliminating weak keys;
generating a random output from said partial fraction output by deskewing said first output; and
generating a predetermined length of a bit stream from said random output of said partial fraction output.

16. A method of generating uncorrelated random bits as recited in claim 15, wherein said process of eliminating weak keys further including a floating-point operation for determining the uncorrelatedness of said bits of said bit stream output.

17. A method of generating uncorrelated random bits as recited in claim 16, wherein said floating-point operation further enhances the uncorrelatedness of said bits of said bit stream output.

18. A method of generating uncorrelated random bits as recited in claim 16, wherein said floating-point operation and length of said key determining the number of fraction bits to disregard.

19. A method of generating uncorrelated random bits as recited in claim 15, wherein said process of generating a random output from said partial fraction output further increasing the randomness of said random output.

20. A method of generating uncorrelated random bits as recited in claim 19, wherein said process of increasing the randomness is accomplished by eliminating successive 1's and 0's and further by replacing consecutive “01” and “10” with a single distinguished bit.

21. A method of generating uncorrelated random bits as recited in claim 15, wherein said generating a stream of uncorrelated random bits from said combined data further comprising:
prescaling said combined data after eliminating weak keys to a predetermined range;
converting said prescaled combined data from an integer to a floating-point number;
generating an output through the operations of obtaining the cubic root of the floating-point number; and
converting said cubic root of the floating-point number to an integer.

22. A method of generating uncorrelated random bits as recited in claim 15, wherein said process of generating a stream of uncorrelated random bits from said combined data further comprising:
prescaling said combined data after eliminating weak keys to a predetermined range;
converting said prescaled combined data from an integer to a floating-point number;
generating an output through the operations of obtaining the inverse cubic root of the floating-point number; and
converting said cubic root of the floating-point number to an integer.

23. An encryption system of encrypting input data through block cipher, comprising:
a first encryption device including:
an irrational number generator operative to generate an interim result from an input key; and
a data combination unit operative to generate data by combining an input data and said interim result;
a plurality of encryption devices coupled to one another in series, wherein a first encryption device in the series being coupled to the first encryption device, each encrypton device including:
an irrational number generator operative to generate an interim result from said input key after being scrambed by a hash operation of an encryption device of the plurality of encryption devices in the present stage; and
a data combination unit operative to generate a subsequent data by combining said data being generated by the preceeding encryption device and said interim result generated by said encryption device of the present stage; and
wherein said data generated by a last encrypton device in the series is provided as the encryption system output.

24. A method of encryption of input data through block cipher, comprising:
a) generating an interim result from an input key by a first encryption device;
b) generating data by combining an input data and said interim result by said first encryption device;
c) generating an interim result from said input key after being scrambed by a hash operation of an encryption device of the plurality of encryption devices in the present stage;
d) generating a subsequent data by combining said data being generated by the preceeding encryption device and said interim result generated by said encryption device of the present stage;
e) repeating processes c) and d) for a predetermined iteration; and
wherein the data generated by a last iteration is being provided as the encryption output.

25. An encryption system of encrypting input data through block cipher, comprising:
a first encryption device including:
a data combination unit operative to generate an interim data from an input key and an input data;
an irrational number generator operative to generate a stream of uncorrelated rantom bits from said interim data;
a plurality of encryption devices coupled to one another in series, wherein each encrypton device including:
a data combination unit operative to generate a subsequent data by combining said data being generated by preceeding encryption device and input key after being scrambled by a hash operation;
an irrational number generator operative to generate a stream of uncorrelated rantom bits from said subsequent data; and
wherein said data generated by a last encrypton device in the series is provided as the encryption system output.

26. A method of encrypting input data through block cipher, comprising:
a) generating an interim data from an input key and an input data;
b) generating a stream of uncorrelated rantom bits from said interim data;
c) generating a subsequent data by combining said data being generated by preceeding encryption device and input key after being scrambled by a hash operation;
d) generating a stream of uncorrelated rantom bits from said subsequent data;
e) repeating processes c) and d) for a predetermined iteration; and
wherein said data generated by a last iteration is being provided as the encryption output.

27. An encryption apparatus for encrypting a bit stream through stream cipher in real-time, comprising:
an irrational number generator operative to generate a stream of random bits from an input key and storing said random bits in a bit buffer; and
a combination unit operative to generate an output stream of bits by combining said buffered stream of random bits and an input bit stream.

28. An encryption apparatus as recited in claim 27, wherein said bit buffer is provided to accommondate different bit rates between said bit stream being generated by said irrational number and the input bit stream.

29. An encryption apparatus as recited in claim 27, wherein said bit buffer is a First-In-First-Out (FIFO) buffer.

30. An encryption apparatus as recited in claim 27, wherein said bit buffer is a dual-ported memory.

31. An encryption apparatus as recited in claim 27, wherein said bit buffer is a single-ported memory.

32. A method of encrypting a bit stream through stream cipher in real-time, comprising:
generating a stream of random bits from an input key and storing said random bits in a bit buffer; and
generating an output stream of bits by combining said buffered stream of random bits and an input bit stream.

33. A method of encryption as recited in claim 32, wherein said bit buffer is provided to accommondate different bit rates between said bit stream being generated by said irrational number and the input bit stream.

34. A method of encryption as recited in claim 27, wherein said bit buffer is a First-In-First-Out (FIFO) buffer.

35. A method of encryption as recited in claim 27, wherein said bit buffer is a dual-ported memory.

36. A method of encryption as recited in claim 27, wherein said bit buffer is a single-ported memory.
